(19) United States
(12) Patent Application Publication
(10) Pub. No.: US 2012/0196079 A1
(43) Pub. Date: Aug. 2, 2012

(54) COMPOSITE BODY

(75) Inventors: Sven BRAUERS, Hannover (DE); Rouven Brauers, Wolfsburg (DE)

(73) Assignee: HYDROFLEX TECHNOLOGIES GmbH, Wolfsburg (DE)

(21) Appl. No.: 13/358,340

(22) Filed: Jan. 25, 2012

Related U.S. Application Data
(63) Continuation of application No. PCT/EP2010/004531, filed on Jul. 23, 2010.

(30) Foreign Application Priority Data
Jul. 23, 2009 (DE) 10 2009 034 534.5
Sep. 1, 2009 (DE) 10 2009 039 534.2

(51) Int. Cl. B32B 3/26; B32B 27/00; B32B 3/12

(52) U.S. Cl. 428/116; 428/304.4; 428/319.1; 428/158; 428/319.7

(57) ABSTRACT

Composite body having a laminate coating at least partially surrounding a core of the composite body, wherein a positive pressure is present at least in a portion of the core that is at least partially surrounded by the laminate coating, or a positive pressure is achievable at least in said portion of the core, in a delamination-free manner. The core is designed at least partially as open-cell foam, and/or a positive pressure is present in at least a portion of the laminate coating or a positive pressure is achievable at least in said portion of the laminate coating, wherein the core is at least partially designed as open-cell foam.

### CROSS-REFERENCE TO RELATED APPLICATIONS

This application is a continuation of application no. PCT/EP2010/004531, filed Jul. 23, 2010, which claims the priority of German application no. 10 2009 034 534.5, filed Jul. 23, 2009, and which claims the priority of German application no. 10 2009 039 534.2, filed Sep. 1, 2009, and each of which is incorporated herein by reference.

### FIELD OF THE INVENTION

The invention relates to a composite body, for example and in particular an aircraft component, sport equipment for surfing, or the like, and uses.

### BACKGROUND OF THE INVENTION

DE 39 40 707 A1 discloses devices for thermal and sound insulation, having a base body made of an elastically deformable base material having predominantly open cells and a barrier layer. The barrier layer is designed as a gas-tight enclosure which surrounds the base body in a gas-tight manner. The air pressure in the interior is less than the air pressure of the ambient air surrounding the enclosure.

DE 603 17 340 T2 discloses insulating structures which are useful in articles of clothing, sleeping bags, air mattresses, and the like, the insulating values of the article of clothing or the other designs being adjustable by the user. The multilayer structure according to the invention includes an insulating layer which is adhesively held in place in the structure with respect to all other components, thus alleviating an existing problem associated with known insulated articles of clothing and the like, namely, migration of the insulation within the article of clothing components, resulting in undesired hot and/or cold areas inside a structure which is intended to be uniformly insulated. In particular, a multilayer composite element which may be inflated with air and deflated is provided, the element comprising at least two layers of a flexible, waterproof, air-impermeable, optionally water vapor-permeable material, and the two layers forming at least one inflatable cell therebetween. The two layers have at least one additional layer made of a porous insulation material situated between the two layers within the cell.

AT 406 341 B discloses in particular a method for manufacturing a molded part having at least one hollow body made of fiber-reinforced plastic, in particular of a ski or ski components, wherein at least one deformable hollow chamber encased by fibrous material impregnated with synthetic resin is shaped in a closed mold by internal gas pressure, and for producing the internal gas pressure inside the deformable hollow chamber, a quantity of liquid which only partially fills the interior of the hollow chamber is introduced, and after the hollow chamber is sealed gas-tight, the liquid is heated to above its boiling point. During curing, this results in material-free cores that are enclosed by individual layers of a covering.

DE 33 15 776 A1 discloses multipart elastic hollow bodies which have different shapes and are enclosed by various different materials, thus forming clusterlike structures, these hollow bodies reinforcing the correspondingly formed structures due to their special design.

AT 403 251 B discloses in particular skis having at least one internal material-free hollow core that is enclosed by multiple layers, the mechanical properties of the skis being changeable by application of pressure.

U.S. Pat. No. 4,753,836 discloses a classical core-laminate coating composite body.

Known devices for surfing, such as surfboards, windsurf boards, skateboards, skimboards, wakeboards, kneeboards, or kiteboards, may be composed of a base body made of foamed material which in a first work step is brought into a desired board-like shape having a top and a bottom side, and in a second work step is provided with laminate coatings. The laminate coatings are applied in two consecutive production steps, since the top and bottom sides of the board-like base body must be laminated separately to obtain complete laminate enclosure of the base body. However, the laminate coating may also be applied in one production step.

U.S. Pat. No. 4,753,836 discloses, among other things, a device, in particular a sport equipment item for surfing or the like, having a base body, made of foamed material, having at least one laminate coating composed of a fabric laminate and a matrix compound, an intermediate layer being provided between the base body and the laminate coating in the form of a board, and the board being laminated onto the base body, and the fabric laminate together with matrix compound being laminated over same.

During use, a surfboard, for example, is subjected to significant load which may result in deformation of the surfboard up to 30 cm. The problem arises that the laminate covering separates at the locations of the base body made of foamed material at which buckling occurs due to the mechanical load on the surfboard. This separation process of the laminate covering progresses upon continued use of the surfboard, as the result of which the surfboard can no longer be properly used, and may break. Furthermore, depending on the intended purpose and the user, due to the varying forces from wind and waves as well as the varying weights of the surfers, the mechanical stresses in particular on surfboards may vary greatly with regard to the device having a core and surrounding laminate coating. For fairly high mechanical forces, for such devices the laminate strengths vary greatly, which is sometimes associated with significant increases in weight which in many cases are not desired.

### OBJECTS AND SUMMARY OF THE INVENTION

It is an object of the invention, therefore, to provide an appropriate composite body which, even under exceptionally high mechanical load, has relatively small laminate coating dimensions, and thus results in a relatively low intrinsic weight. Furthermore, it is an object of the invention to provide an appropriate composite body that is suitable for various stresses and loads without material failure.

This object is achieved according to the invention by a composite body according to claim 1, and use according to claim 37.

The body according to the invention has a core which is designed at least partially as open-cell foam, for example and in particular made of polystyrene, and a laminate coating which at least partially surrounds this core. Positive pressure is present at least in a portion of the core and/or at least in a portion of the laminate coating, or positive pressure is achievable at least in a portion of the core and/or at least in a portion of the laminate coating, for example and in particular by introducing air via a means for adjusting the positive pressure, for example and in particular via a valve, so that according to the invention, the flexural strength of the body may be significantly increased according to the invention in a range of up to approximately 0.5-5 bar without otherwise customary delamination occurring, which would result in complete destruction of the body. This requires an intimate bond of the individual layers in the laminate coating, it being particularly advantageous when the laminate coating has at least one fabric laminate and a matrix compound, with an intermediate layer between the core and the laminate coating and/or with an intermediate layer between a core layer of the laminate coating and at least a portion of the laminate coating, the intermediate layer having a foam layer that is provided with indentations. Such a design achieves this type of intimate bond of the individual layers with one another or between the core and the laminate coating, wherein for a design having a core layer, the layer is made of a core material, in particular foamed material, in the laminate coating, so that when internal pressure is applied by the tensile and compressive forces that are present, the delamination processes in particular do not occur; thus, the core layer functions as a supplement to the core, in a manner of speaking.

It is advantageous that the positive pressures in the core and in the laminate coating are or may be adjusted independently, since in this way the properties, in particular with regard to the flexibility of the composite body, may be adjusted in a particularly accurate manner. This may be achieved, for example and in particular, in that individual valves or valve shafts thereof project on the one hand into the core and on the other hand into the laminate coating, in particular the core layer.

The bond between the core and a laminate covering composed of two laminate coatings may be significantly improved, even under extreme mechanical loads, by an intermediate foam layer having indentations. In addition, an optimal combination of lightness, flexibility, and stability may be achieved in this way.

The matrix compound may penetrate into the indentations in the foam layer which have been introduced into the core and/or the core layer, resulting in an improved bond between the surface of the foam core and/or the foam core layer and the laminate covering due to the enlarged surface and the improved engagement by the roughened surface.

It is preferably provided that the indentations are grooved, so that along the linear grooves a particularly strong bond is present between the base body made of foamed material and the laminate covering.

In one preferred embodiment, it is provided that at least sections of fabric laminate are situated in the grooves at least in places. The strength may thus be greatly increased, for example, by milling multiple, preferably 1 to 20, grooves extending in the longitudinal direction into the base body and subsequently pressing the fabric laminate into the grooves, for example with the aid of a suitable tool. The grooves may be filled with matrix compound before the fabric laminate is pushed in. The fabric laminate may be applied in the form of fabric laminate strips having a width of 15 to 35 cm, for example. However, fabric laminate strips having a smaller or greater width, or a fabric laminate layer that covers the entire surface, may be used. The laminate coating is subsequently sealed off by applying a matrix compound. Thus, the fiber proportion may be increased up to 80%, which further increases the stability and strength.

The grooves have a depth of up to 4 cm in order to provide a bond between the core or the core layer made of foamed material and the laminate covering, which is resistant to even extreme mechanical loads.

The grooves extend in parallel and/or in intersection with one another on the surface of the base body in order to improve the bond independently of direction.

In another embodiment it is provided that the indentations are countersunk. The countersunk indentations may be conical or cylindrical, and have a depth of up to 8 cm and a diameter of up to 5 mm. However, the indentations may also join the top and bottom sides of the board-shaped core or the core layer together by forming passages, so that the two laminate coatings are directly joined together by matrix compound in the passages. However, the indentations preferably have a depth of 1 to 2 cm and a diameter of 1 to 3 mm, the indentations preferably being situated uniformly. Thus, the core or the core layer has a uniform pattern with indentations into which the matrix compound may penetrate, thus improving the bond between the base body made of foamed material and the laminate covering. However, the base body may also be provided with a nonuniform pattern.

It is preferably provided that the intermediate layer contains material of the core and of the matrix compound. As the result of combining these two materials in the intermediate layer, the intermediate layer has mechanical properties which reduce the mechanical stresses that occur due to mechanical load at an interface of two different materials.

In another embodiment it is provided that the intermediate layer contains material of the fabric laminate. Fabric laminate sections may be pressed into the core or the core layer, or the core or the core layer is coated with the fabric laminate and the fabric laminate is subsequently pressed into the body or the core layer in places. Devices such as a jigsaw having a blunt tip or a blunted needle roller may be used for this purpose. This type of device also withstands extreme loads.

The fabric laminate is preferably made of synthetic and/or natural fibers, glass fibers, aramide fibers, polyethylene fibers, polypropylene fibers, mixed fibers, carbon fibers, polymethacrylimide (PMI) fibers, glass filament fabric, carbon fabric, fiberglass fabric, hemp fiber fabric, Dyneema fibers, bamboo fabric, texalium fibers, Parabeam (spacer fabric), cotton fibers, Kevlar fibers, basalt fabric, fiberglass multilayer structure/fabric, glass roving fabric, or a combination of the named materials.

In one preferred embodiment, the fabric weight per unit area for glass fibers is 80 g/m² to 480 g/m², and for aramide is 60 g/m² to 400 g/m². If particularly high loads are expected, the fabric weight per unit area for glass fibers or aramide may be up to 1000 g/m².

The fabric laminate preferably has at least one weave from the group composed of plain weave, 1/3 twill, 2/2 twill, unidirectional, glass staple fiber fabric, glass roving fabric, multilayer carbon fabric, and biaxial multilayer structure.

Known foamed materials may be used which after production may be open-cell to closed-cell, although foamed material made of polyurethane or polystyrene, which is easy and inexpensive to process, is preferred. In addition, PVC, Corecell SAN, extruded polystyrene (XPS) foam, polymethacrylimide (PMI) foam, polymethacrylamide (PMA) foam, expandable polystyrene (EPS) foam, styrene acrylic nitride (SAN), SP 110 polymer foam, or phenol foam may be used. Furthermore, acrylic, EPS, polyurethane (PU), polyvinyl chloride (PVC), polyethylene terephthalate (PET), and PP foams, toluene diisocyanate (TDI), 4, 4′-methylene diphenyl isocyanate (MDI), balsa wood, maize, Honeycomp, polyethylene (PE), and polyetherimide (PEI) may be used.

A natural resin and/or a synthetic resin, an unsaturated polyester (UP) resin, epoxy (EP) resin, vinyl ester (VE) resin, or polyurethane (PU) resin is/are preferably used as matrix compound. Foam materials such as polyurethane or polystyrene may be easily coated or encased using these materials together with the above-mentioned fabric laminates.

In one special embodiment, fillers are added to the matrix compound. These fillers may be hollow glass beads, talcum, wood flour, glass fiber chips, fiberglass chips, cotton flock, microballoons, powdered aluminum, ground carbon fibers, chalk, quartz powder, ground hemp fibers, silicic acids, or dyes, or nanoparticles, in particular and for example made of carbon (Baytubes from Bayer, for example) or made of titanium (Ocean IT, for example), or a combination thereof. By using these fillers, the adhesion and processibility of the matrix compound may be favorably influenced, and the mechanical properties may be adapted to those of the core or the core layer made of foamed material, thus avoiding separation of the laminate coating or covering from the core or the core layer.

In addition, it is advantageous when the core has at least one channel-like element, for example and in particular in the form of a channel or a tube, for example and in particular made of polyethylene or PVC, which extends at least partially through the core to allow more rapid pressure compensation in the core itself when appropriate pressure is applied.

Furthermore, it is advantageous when the core has, at least in part, at least one honeycomb-like structural element for increasing the mechanical stability of the core with a relatively small weight increase.

It is also advantageous when the core has, at least in part, a combination of foams, for example polyurethane foams, to allow a customized adaptation to the particular fields of application.

In addition, it is advantageous when the core contains, at least in part, fiber mats, plates sewn through with fiberglass, or fiber-reinforced foams, since these have been proven to be extremely reliable in practice.

Furthermore, it is advantageous when the positive pressure is achieved by means of at least one member of the group composed of air, nitrogen, noble gas, and fluid, in particular water and oils, since these have been proven to be suitable in practice.

It is also advantageous when the laminate coating has an opening element, for example and in particular in the form of a drain plug or a rotary valve, to remove liquids, in particular water, which may have undesirably penetrated, in a relatively elegant manner by discharging from the composite body.

In addition, it is advantageous when the composite body according to the invention has a pressure measuring element to allow reliable and secure tracking of the pressure conditions when appropriate pressure is applied, thus preventing application of positive pressure in the event of material failure.

Lastly, it is advantageous when the means for adjusting a negative or positive pressure has a cover element and/or is embedded in the composite body in order to mechanically protect same.

In general, it is noted that according to the invention, due to an extremely intensive, strong bond between the individual layers of the laminate coating and/or between the material core and the laminate coating and/or between the core layer and at least one additional layer of the laminate coating, this bond is pressure-tight at least to a maximum pressure of approximately 5 bar, so that material failure does not occur when either a positive pressure or a negative pressure is applied, and also that the composite body according to the invention becomes more rigid when a positive pressure is applied. In this context, it is very advantageous when the laminate coating is gas-tight in order to avoid interfering pressure losses due to leaks.

In addition, the rigidity of such a structure may be increased when pressure is applied, or reduced under negative pressure, so that in the case of surfboards, for the appropriate application [of pressure] the rigidity of the surfboard may be optimally adapted to the particular wave conditions. Thus, the flexibility is adaptable, and in addition, absorption of liquid, in particular water, is avoided by establishing a positive pressure, or water or other liquids already present in the composite body according to the invention are even appropriately discharged via a drain valve that may be present.

The material properties, in particular the flexibility of the composite body, may be satisfactorily adjusted in particular when the ratio of the laminate coating thicknesses on opposite sides is advantageously in the range of 1:1 to 1:3. The necessary internal bonding of the individual laminate layers in the laminate coating itself is achieved, for example and in particular, in that the laminate coating has at least one fabric laminate and a matrix compound, with an intermediate layer between the core and the laminate coating, and/or with an intermediate layer between a core layer of the laminate coating and at least a portion of the laminate coating, the intermediate layer having a form layer that is provided with indentations. Reference is made to the statements made at this point in the description. In the case of negative pressure, this has a favorable effect on the possible delamination behavior of the laminate coating, since the laminate coating is retained on the core or the core layer, and cannot slide off by delamination. The properties of the composite body according to the invention may thus be appropriately adapted in particular with regard to rigidity and buckling resistance (as discussed above), in addition a marked increase in the security of a composite body being achieved, since in the event of an inadvertent pressure compensation or pressure loss the composite body has sufficient residual stability in order to avoid complete failure. If the core is composed predominantly of open-cell foams, in particular water absorption may be completely and reliably prevented by positive pressure that is present. Complex, cost-intensive repairs as the result of penetrated water and problems from osmosis may be reliably prevented in yacht construction, for example.

For a design in particular having a core which is composed of a foamed material or multiple foamed materials, shapes to be produced may be created relatively freely by milling or by hand, for example by forming from foam blocks. By preventing delamination or a so-called shear failure, i.e., the occurrence not only of buckling but also the actual “fracturing” of the different material laminate layers downward into the core when pressure is applied, [omission] is achieved by appropriate application of positive pressure in the core, and thus a much higher stability with a very large weight savings is realized compared to conventional methods, in which appropriate solid form elements are incorporated on or in the core, for example the so-called stringer, generally made of wood, for surfboards, the above-mentioned avoidance of external surface buckling thus resulting in so-called “buckling rigidity,” which no longer necessarily has to be achieved by increasing the laminate coating thickness or by increased density of a foam core, but, rather, this being provided by applying pressure in the core, resulting in significant weight savings. Thus, the composite bodies according to the invention are dimensionally stable and their dimensions are accurately reproducible, and furthermore their characteristics are controllable by changing the pressure, which has a direct effect on the characteristics of the composite body. For example, an aircraft wing or a blade of a wind turbine may be adapted to the particular prevailing conditions or fields of application; the higher the pressure, the more rigid the structure per se. In addition, a high degree of safety from damage is achieved, since such damage, which results in a change in the internal pressure, may be immediately identified and is easily measured. Another advantageous is that outgassing occurs very slowly due to the complex structure of the foams generally used, so that for a surfboard that is 2 m in length, having a hole 10 cm in diameter, a measurable internal pressure is still present after approximately 1 hour.

Possible applications, for example and in particular, are surfboards, aircraft wings, wind turbines, yacht construction, the automotive field, and architecture.

Surfboards: The characteristics of a surfboard may be individually adapted, wherein a low application of pressure results in increased flexibility. For large waves, the board may be stiffened by increasing the internal pressure. At the same time, the internal pressure greatly increases the stability of the board. The larger the waves, the higher the internal pressure, and the more stable the board. As the result of positive pressure, no water is absorbed in the event of damage.

Aircraft wings: The flexibility and characteristics may be optimally adapted to the speed and the flight behavior. The stability is increased, and at the same time weight savings are achieved. Good monitoring options in the event of damage from a drop or rise in internal pressure are apparent. A broad field of applications in particular for ultralight and sport aircraft is conceivable.

Wind turbines: For wind turbines, an increase in the efficiency by adapting the blade characteristics to the particular wind conditions is possible by adjusting the stability of the blades, and a generally large weight savings is achieved compared to conventionally reinforced blades.

Yacht construction: In this area as well, expensive specialty foams for increasing the buckling resistance may be dispensed with, in which damage immediately results from a drop in pressure. In the event of damage, water cannot be absorbed on account of the positive pressure that is present, so that costly repairs may be avoided. If damage occurs, air may be replenished via a compressor until it is possible to repair the damage. A change in the hull characteristics by varying the internal pressure is conceivable.

Automotive: The use of spoilers, in particular in motorsports, may be adjusted by adapting the rigidity of the spoiler to the speed of the vehicle.

Architecture: Self-supporting lightweight structures, in particular roofs and walls, are conceivable.

The composite body according to the invention may be manufactured using the following steps, illustrated with reference to a surfboard:

1. Bringing a core made of foam into a desired shape,

2. At least partially coating the core by lamination,

wherein prior to the second step at least a portion of the surface of the core to be coated is provided with indentations or elevations. The method according to the invention is based on the surprising finding that the bond between the core and a laminate coating may be improved when an intermediate layer is present between the core and a laminate coating after step 2, the intermediate layer having a layer made of foamed material which is provided with indentations.

The indentations are preferably composed of grooves and/or countersunk holes, so that the matrix compound is able to penetrate along the linear grooves and into the countersunk holes situated at the surface, resulting in an improvement in the bond between the core or the core layer and the laminate coating.

In one preferred embodiment, it is provided that fabric particles are introduced into at least a portion of the indentations prior to the second step. The fabric particles may be appropriately sized sections of the fabric laminate, or sections of the fabric laminate which has been applied over the surface of the core or the core layer and pressed (stitched) into the core at selected points. In this way the fiber volume in the intermediate layer may be increased, resulting in increased mechanical load capacity.

In another embodiment, it is provided that the indentations are at least partially filled with a matrix compound before the fabric particles are introduced. A particularly strong fiber composite, in particular for sport equipment for surfing or an aircraft composite body, may be obtained in this manner.

The indentations may be produced by milling, for example using a CNC machine, drilling, punching, cutting, ramming, or other methods. For example, multiple, for example 1 to 20, grooves extending in the longitudinal direction of the core or the core layer may be introduced by milling into the core or the core layer. The introduced grooves are dimensioned in such a way that the fabric laminate may be pressed into the grooves at least in places, for example using a suitable tool, before the laminate coating is completed by applying a matrix compound. The grooves may be filled with matrix compound before the fabric laminate is pressed in. Alternatively, the grooves may be filled afterwards. By pressing in fiber particles, a fiber proportion of up to 80% may be achieved, which increases the strength and stability. Furthermore, it is provided that the grooves and/or countersunk holes are produced by pressing into the surface of the core or the core layer. Material-removing production processes, which are harmful to health due to dust production, are therefore not necessary.

It is preferably provided that the grooves are produced in a first step, and countersunk holes are introduced into the surface of the core or the core layer in a second step. The grooves are preferably produced using a milling machine, while the countersunk holes are produced also using a needle roller. Thus, the deeper and larger countersunk holes do not hinder the introduction of grooves on the surface of the core or the core layer, using a comb.

In one preferred embodiment, it is provided that the base body is coated with the matrix compound after indentations are introduced into the surface of the core or core layer (referred to below as “base body”). As a result of this coating process, the matrix compound is able to penetrate into the grooves and/or countersunk holes previously introduced into the surface of the base body, and at the same the bond to the fabric laminate to be applied is improved.

Different matrix compounds may be used for the coating and for the lamination. However, it is preferably provided that the same matrix compound is used in order to optimize the bond between the matrix compound introduced into the grooves and/or countersunk holes and the matrix compound used for the lamination.

In one preferred embodiment, the lamination is performed by hand, using a vacuum press, the autoclave process, the roving-winding process, or the injection process.

In manual lamination, the fabric laminate is placed on the scraped base body. Matrix compound is subsequently poured onto the fabric laminate and rubbed into the fabric laminate lying on the base body. Primarily brushes and groove rollers/velour rollers are used as tools for this purpose. A tear-off fabric is then placed thereon. The tear-off fabric, made of Nylon fibers, for example, may be peeled or torn off after the matrix compound cures, thus producing a clean, adhesive-free surface of defined roughness which may be further processed. The laminates are cured without pressure, at room temperature. Hot- and cold-curing matrix compounds exist which cure at temperatures from 10 to 230° C. Further processing may be subsequently carried out.

For vacuum pressing, the base body previously laminated by hand is inserted into an evacuatable film bag. After the air is suctioned out, the film presses against the laminate and pushes it onto the mold. The maximum pressure is specified by the ambient air pressure, and is approximately 1 bar maximum. The fiber fraction of the laminate may be increased, and excess matrix compound pushed out, by vacuum pressing. In addition, lightweight support materials such as plastic foams or honeycombs having high-strength cover layers made of resin or fabric may be adhesively bonded, thus forming an extremely lightweight, strong component. A uniform contact pressure is required. For this purpose, the laminate is initially covered with a tear-off fabric and a nonadhesive perforated film. An air-permeable, absorbent nonwoven is placed thereon for uniformly distributing the vacuum and drawing off excess matrix compound from the laminate. The subsequent curing may occur at room temperature, although tempering is also possible.

In the autoclave process, a tear-off fabric, a perforated film, an absorbent nonwoven, and a vacuum film are also used, followed by production of a vacuum. The matrix compound may be cured at a pressure of 6 bar, and at temperatures of 170° C. or room temperature.

Another method is the injection process, in which dry fabric laminate is placed on the base body. The fabric laminate is impregnated with the matrix compound only after a vacuum has been produced.

Another advantageous device is characterized in that the device has a surface having roughness elements at least in places. The water resistance may be significantly reduced by this type of surface structuring, so that much higher speeds may be achieved.

Another advantage is that due to the rough surface it is no longer necessary to rub in wax at least on the top side of such a board, which is intended to ensure a secure standing position on the board and to increase the grip of the board. Thus, the labor-intensive coating with wax, as well as the likewise labor-intensive removal of the wax after use of the board, are dispensed with. In addition, it is problematic that the wax softens under sunlight and adheres upon contact, resulting in considerable soiling, for example in the interior of a passenger vehicle.

It is preferably provided that the indentations have a point-symmetrical design and are arranged independently of direction. Thus, the surface structure results not only in increased speed in one direction, but also in reduced water resistance in all directions, i.e., also for backward or lateral motions. The structure according to the invention is thus particularly suited for surfboards, wakeboards, or kiteboards.

In one preferred embodiment, the maximum surface roughness of the indentations is up to 1000 μm, preferably between 60 and 150 μm. The maximum surface roughness is defined as the vertical distance between the highest and lowest points of a (filtered) roughness profile within a measured distance, in accordance with DIN 4762.

The mean roughness value is between 5 and 100 μm, preferably between 10 and 15 μm. The mean roughness value is defined as the arithmetic mean of the profile deviations of the (filtered) roughness profile from the median line within the measured distance, in accordance with DIN 4786, DIN 4762, and ISO 4287/1.

Another advantageous embodiment is characterized in that the surface of the laminated base body is provided with roughness elements at least in places. The roughness elements have a maximum surface roughness of up to 200 μm, preferably between 60 and 150 μm, the mean roughness value being between 5 and 50 μm, preferably between 10 and 15 μm, since experimental studies have shown that at these values, on the one hand a marked reduction in the water resistance is achieved, and on the other hand a sufficient grip of the surface is provided which allows use of a wax coating to be dispensed with.

These roughness elements may be produced by pressing or pushing in, and by means of cutting processes. However, it is preferably provided that during the lamination a tear-off fabric is applied to the base body, and is removed after the lamination is completed. It is known to use a tear-off fabric for lamination by hand, using a vacuum press in the autoclave process and in the vacuum injection process. The tear-off fabric is placed on the laminate before the matrix compound cures.

In one preferred embodiment, it is provided that the surface provided with roughness elements is coated with a compound. This compound, having a suitable low-viscosity consistency, penetrates into the indentations and collects at the base of the indentations so that the indentations are partially filled, thus homogenizing the roughness profile by filling the deepest indentations.

It is provided that the low-viscosity compound contains polyester resin, Teflon, epoxy resin, acrylic lacquer, or Lotus lacquer.

The tear-off fabric is preferably made of Nylon fibers, and may be peeled or torn off after the matrix compound cures. The tear-off fabric may also be made of other materials which do not absorb the matrix compound and therefore do not bond with the cured matrix compound. After the tear-off fabric is torn off, a rough, clean, and adhesive-free surface remains which may be further processed. It has surprisingly been shown that the surface structure which results after removal of the tear-off fabric is provided with direction-independent roughness elements which result in a noticeable reduction in the water resistance.

The tear-off fabric preferably has a plain or twill weave having a regular structure.

In one special embodiment, the tear-off fabric has a weight per unit area of 50 to 120 g/m², preferably 90 to 110 g/m². The composite body according to the invention may be used in particular as a water sport equipment item, sport equipment for surfing, a kiteboard, wind surfboard, paddleboard, waterskate, sport equipment, snowboard, ski, or kayak, as a component in aircraft construction, such as a wing element, wings for ultralight aircraft, elevators and rudders, as a component in automotive construction or automotive assembly, such as a body part, spoiler, turret, or hood, as a component in ship construction, such as a hull assembly or hull, as a component in wind turbines, such as a wind turbine blade or wind turbine rotor blade, as an underwater turbine blade, or as a component in building construction, such as a canopy or winter garden frame.

### Yacht Construction

### Advantages for Yacht Construction:

Reduction in weight
Higher load capacity
Control adaptability
Better insulation (more air, less mass)
Avoidance of osmosis since water is not able to penetrate.

### Yacht Construction/Layer Structure:

Gel coat
1000-5000 g/m² fabric (fiber, carbon, basalt, Kevlar, hybrid)
Intermediate layer
30 kg/m³ open-cell foam
Intermediate layer
1000-5000 g/m² fabric (fiber, carbon, basalt, Kevlar, hybrid).

### Wind Power

### Advantages for Wind Power:

Damage may be monitored
The rigidity of the rotor blades is adaptable to wind conditions.

### Wind Turbine (3 m Blade Length):

17 kg/m³ Schurg EPS
Intermediate layer
320-640 g/m²
Gel coat.

### Wind Turbine, Up to 50 m Blade Length (i.e., Only One-Half Shell Structure):

˜1000-2000 g/m² Biax glass
Intermediate layer
30 kg/m³ open-cell foam—previously:
20 mm PVC foam, 60 kg/m³
Intermediate layer
1000-2000 g/m² Biax glass.

### Automotive

### Advantages for Automotive:

Minor dents are easily removed
Very good sound damping and insulation

### Lightweight

### Recyclable.

### Kevlar:

High mechanical load capacity
High cost efficiency.

### Structure for Refrigerated Transport Vehicles (Design of Plates):

Laminate approximately 500-1000 g/m²
Intermediate layer
Foam
Intermediate layer
Laminate approximately 500-1000 g/m².

### Aircraft Construction

### Advantages of Aircraft Construction:

Weight savings
Regulation of flexural behavior of the wings, so that adaptation to the flight situation is possible.

### Aircraft Wings for Ultralight Gliders:

200-400 g/m² carbon fabric (Interglass 98 . . . )
Intermediate layer
5-10 mm styrofoam (previously PVC 60 kg/m³ or Depron)
Intermediate layer
200-400 g/m²

In principle, among other factors the compressive strength of the foam is increased without an increase in weight.

### Example 1

BASF EPS 10, with a density of 10 kg/m³, has a pressure stability of 0.15 kg/cm².

After 0.3 bar positive pressure was introduced into the foam core, the compressive strength increased to 0.45 kg/cm². Thus, the compressive strength is comparable to a much heavier foam, for example BASF EPS 30 (density 30 kg/m³). The effect may be further intensified by a continued increase in the positive pressure.

### Example 2

Schurg 18 kg/m³, compressive strength 0.6 kg/cm².

After application of 3 bar positive pressure, the compressive strength increased to 3.6 kg/cm² without an appreciable increase in weight.

To achieve the same compressive strength in the conventional manner, it would be necessary to use, for example, very expensive PVC or high-tech foams having a much higher density (80-120 kg/m³) and an accordingly higher weight.

The invention is explained below with reference to the drawings.

### BRIEF DESCRIPTION OF THE DRAWINGS

The drawings show the following:

FIG. 1 shows a schematic section of a device according to the invention,

FIG. 2 shows an enlarged detail of the device according to the invention shown in FIG. 0 [sic; 1],

FIG. 3 shows a top view of a first embodiment of a device according to the invention,

FIG. 4 shows a top view of another embodiment of a device according to the invention,

FIG. 5 shows a cross section of a device according to the invention, and

FIGS. 6-9 show surface profiles of a surfboard according to the invention.

### DETAILED DESCRIPTION OF THE INVENTION

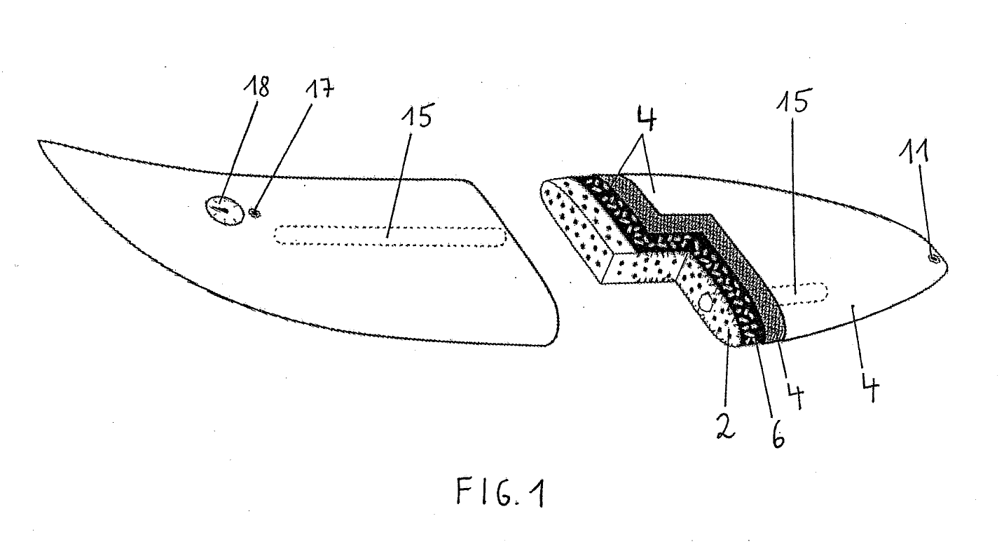

Reference is made to FIGS. 1 through 9.

The device comprises a core 2 made of polyurethane or polystyrene or some other foamed material, the top side of which is provided with a laminate coating 4 composed of a fabric laminate and a matrix compound. Located between the core 2 and the laminate coating 4 is an intermediate layer 6 which is made of a surface section of the core 2 that has been provided with a plurality of differently shaped indentations, into which the matrix compound, with which the fabric laminate has also been impregnated, has penetrated. A means M, namely, a valve, for adjusting the negative or positive pressure is situated at the right rear end of the device. This means may be securely anchored by careful drilling through the laminate coating 4 and adhesively bonding the means in such a borehole, although other approaches are possible, for example screwing into a thread provided for this purpose. The core also has two channel-like elements 15 in the form of tubes which ensure more rapid pressure compensation in the core 2. Furthermore, at multiple locations (of which only one location is illustrated in FIG. 1 by way of example) multiple honeycomb-like structural elements 16 are present which are used to increase the strength of the core without having to deal with a large weight increase. In addition, the laminate coating 4 has an opening element 17 in the form of a rotary valve which is used to discharge undesired gases or liquids inside the core, as well as a pressure measuring element 18 which is used to monitor the pressure conditions in the core and which allows the user to make an appropriate rapid correction to the desired pressure conditions in the core material.

As an alternative to the embodiment in which the core 2 is implemented as foam, in the extreme case the core may also have a material-free design, in which case, however, a core layer K made of foam must be present in the laminate coating 4, so that within the laminate coating 4 an appropriate secure bond may be achieved between individual laminate layers or at least a portion thereof; in this regard, reference is made to the following discussion in the description concerning an intermediate layer 6 between the core 2 and the laminate coating 4.

A plurality of roughness elements 8 whose purpose is to reduce the water resistance is situated on the top side of the laminate coating.

A manufacturing method is explained below.

The core 2 is brought into a desired shape, that of a surfboard, for example, using grinding machines, planes, saws, and abrasive paper, or using a CNC machine.

Grooves are pressed into the surface of the core 2 in a further step, using a milling cutter. The entire surface of the core 2 is then provided with countersunk holes, using a coarse needle roller. This work step is then repeated, using smaller needles in the needle roller. The needle rolling is carried out in various directions, and these work steps are repeated as often as necessary to produce a uniform structure on the surface. Particularly good adhesion of the laminate coating 4 to the core 2 may be achieved by the combination of producing countersunk holes using needle rollers and producing grooves using a milling cutter.

In areas having high mechanical stress, the surface may be provided with a particularly large number of indentations in order to achieve a particularly resistant bond between the core 2 and the laminate coating 4 in these areas.

The cleaned core 2 is then coated or scraped with the matrix compound, so that the matrix compound runs into the produced countersunk holes and grooves 10, thus ensuring an optimal bond between the core 2 and the laminate coating 4.

This coating of the core 2 with the matrix compound ensures that the matrix compound runs into the indentations, and that the matrix compound is not absorbed by the fabric laminate.

The following resins are suited as preferred matrix compounds:

Unsaturated polyester resins, bioresins, epoxy resins, vinyl ester resins, and polyurethane resins. These resins may be provided with fillers such as hollow glass beads, talcum, wood flour, glass fiber chips, cotton flock, powdered aluminum, ground carbon fibers, chalk, quartz powder, ground hemp fibers, silicic acids, and dyes.

At the start of the actual lamination, a glass filament fabric, aramide fabric, carbon fabric, fiberglass fabric, hemp fiber fabric, Dyneema, bamboo fabric, or veneer, or a combination fabric made of the named materials is provided together with the matrix compound on a separate table.

The fabric laminate is then placed on the core 2. The ratio of the fabric laminate layer thickness on the top side to that on the bottom side may be 1:1 to 1:3. The laminate coatings of the top and bottom sides overlap one another, so that in the region of the connecting edges a double laminate coating is provided to ensure a bond, also at the connecting edges, which is sufficiently stable under load.

Possible inclusions of air bubbles are rubbed out with the aid of a spatula after the fabric laminate is laid down.

In a further work step, a tear-off fabric which is not absorbent, and which therefore does not absorb the matrix compound, is applied. The tear-off fabric, made of Nylon and having a plain or twill weave, has a weight per unit area of 50 to 120 g/m². Tearing off the tear-off fabric roughens the surface of the base body 2, resulting in better adhesion of the final surface coating.

Possible inclusions of air bubbles are likewise rubbed out with the aid of a spatula while the tear-off fabric is being laid down.

A vacuum perforated film which is used for pressing laminates is then laid down.

An absorbent nonwoven, used for absorbing the excess matrix compound which is pushed out during the vacuum process, is then laid down. Lastly, the entire structure is enclosed in an air-tight vacuum bag which is attached to a vacuum pump, so that a pressure of approximately 0.75 bar acts on the laminate for eight hours, for example. After this process is completed, the laminated core 2 is removed from the absorbent nonwoven and the perforated film, and the tear-off fabric is then removed. After the tear-off fabric is removed, multiple roughness elements 8 which have a point-symmetrical design and are arranged independently of direction remain on the surface.

This is followed by coating of the second side of the board-shaped body, which is laminated in the corresponding manner.

To complete a surfboard, fins and leash plugs must also be set in place.

The method for manufacturing a surfboard is thus complete, and the surfboard is finished. Multiple applications of a matrix compound as well as the subsequent labor-intensive grinding are no longer necessary; due to the lack of a final coating, the surfboard is approximately 15 to 20% lighter.

In this manufacturing method, production of a negative form is not necessary; instead, individual forms may be provided with a laminate covering. Thus, the method is not only suitable for manufacturing fiber composites for sport equipment such as surfboards, for example, but may also be advantageously used in other fields such as prosthetics construction, aviation, or automotive construction.

Besides the described vacuum process, an injection process may be used. In this process, the matrix compound is drawn into the fabric laminate by the vacuum, the matrix compound being provided with transport channels which ensure optimal distribution of the matrix compound. The orientation of the fibers of the fabric laminate is maintained due to the low flow rate of the matrix compound, resulting in reproducible good mechanical properties.

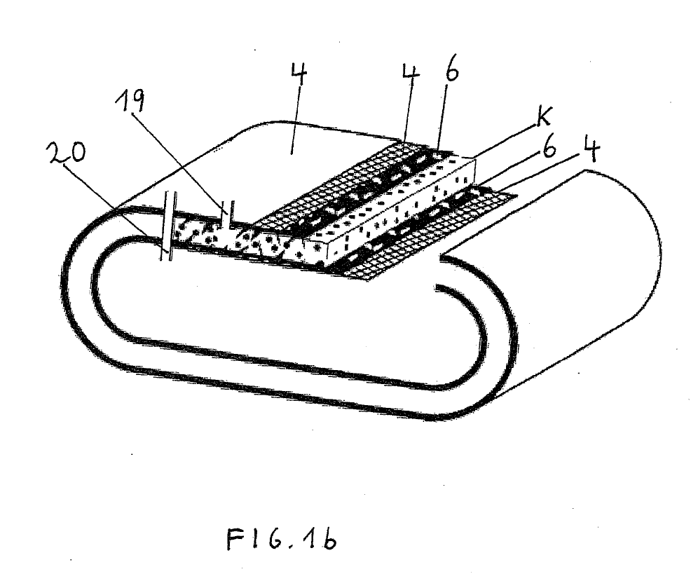

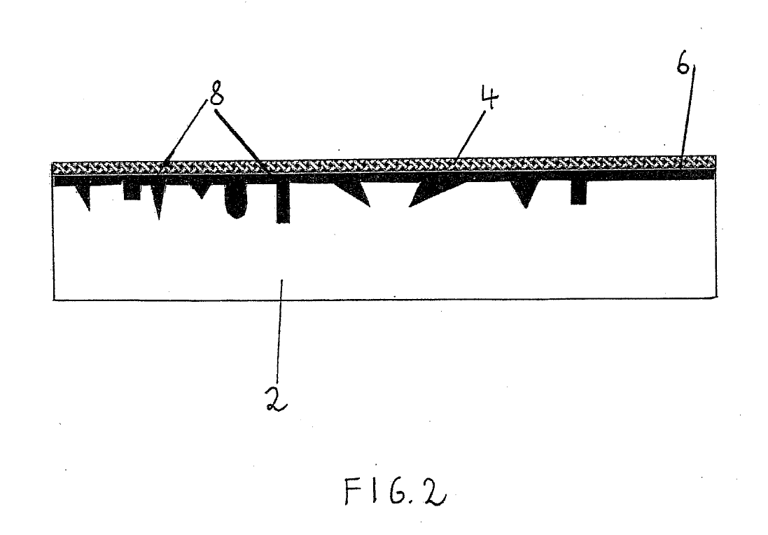

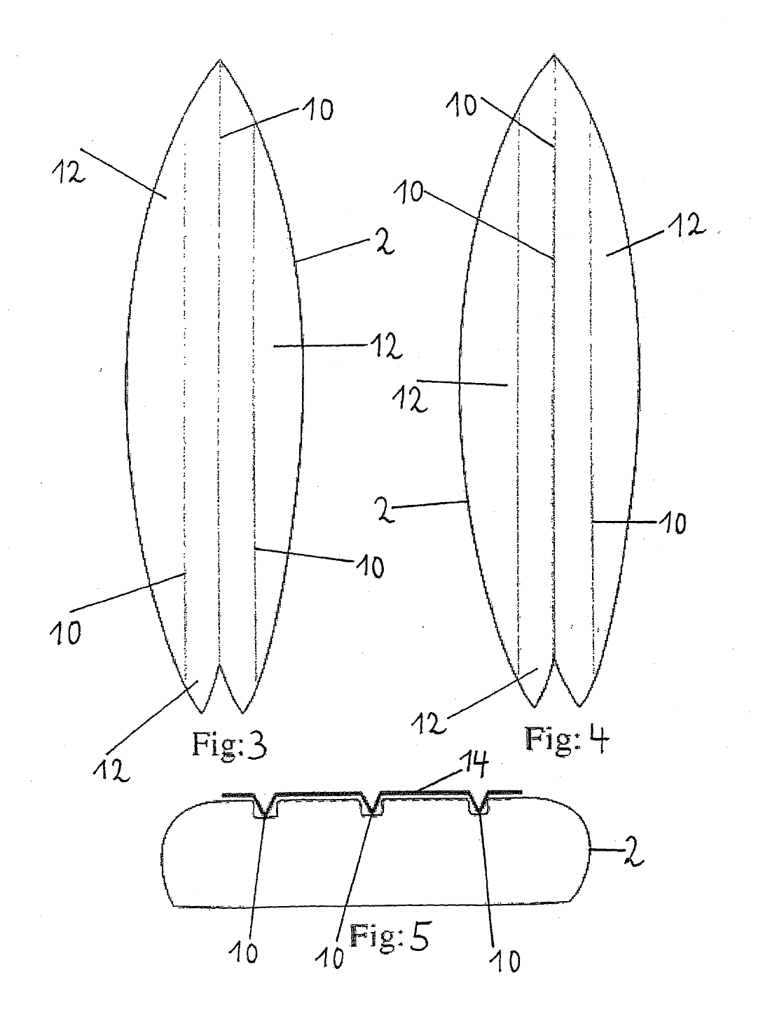

Reference is made to FIGS. 3 through 5 by way of example. The surfboard-shaped base bodies 2 are provided with three grooves 10, extending in the longitudinal direction, which have been filled with a matrix compound, for example a resin or a resin-containing compound, prior to the lamination. However, other matrix compounds may also be used. Fabric laminate strips 12 having a width of 15 to 20 cm are applied to the grooves 10 filled with matrix compound (see FIG. 2). However, fabric laminate strips 12 having a greater width (up to 35 cm) may also be applied to the core 2 (see FIG. 3), or a fabric laminate layer 14 may be applied over the entire surface. Prior to a final laminate coating, the fabric laminate strips 12 or the fabric laminate layer 14 is/are pressed into the grooves 10, the sections of the pressed-in fabric laminate strips 12 or the fabric laminate layer 14 being impregnated with the matrix compound with which the grooves 10 are filled.

Alternatively, the fabric laminate strips 12 or the fabric laminate layer 14 may be pressed into the grooves 10 first, followed by a step in which the matrix compound is applied to the core 2 prepared in this manner, and penetrates into the grooves 10 together with the fabric laminate strips 12 or fabric laminate layer 14 which have been pressed in sections. The fabric laminate strips 12 or the fabric laminate layer 14 may be pressed in with the aid of a tool.

By pressing in fabric laminate strips 12 or a fabric laminate layer 14 in sections, the fiber proportion may be increased up to 80%, which further increases the strength and stability.

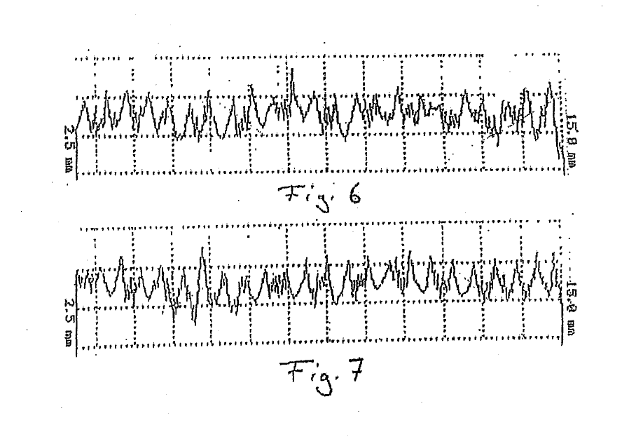

Reference is made to FIGS. 6 through 9.

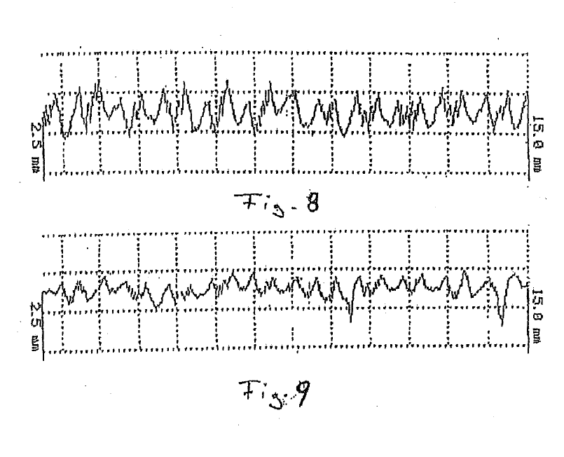

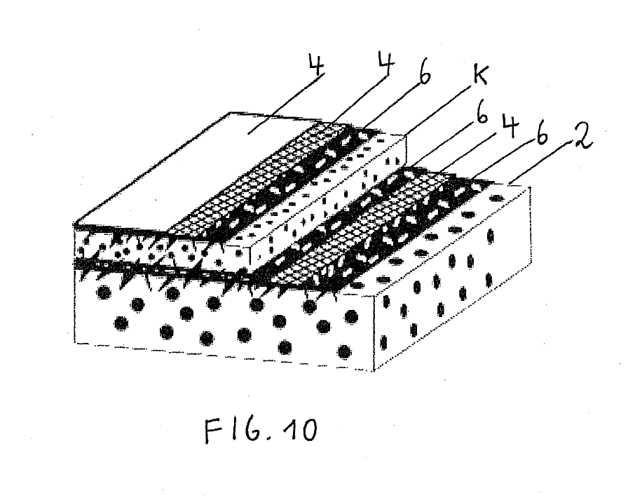

FIGS. 6 through 9 show surface profiles of surfboards according to the invention. The maximum surface roughness is [defined] as the vertical distance between the highest and lowest points of the filtered roughness profile within the measured distance. The surface profile in FIG. 5 has a maximum surface roughness of 118.5 μm, while the surface profile in FIG. 6 has a maximum surface roughness of 96.64 μm, the surface profile in FIG. 7 has a maximum surface roughness of 71.20 μm, and the surface profile in FIG. 8 has a maximum surface roughness of 140.8 μm.

The mean roughness value, which is defined as the arithmetic mean of the (filtered) roughness profile from the median line within the measured distance in accordance with DIN 4786, DIN 4762, and ISO 4287/1, is 12.62 μm for the surface profile in FIG. 5, 12.09 μm for the surface profile according to FIG. 6, 11.6 μm for the surface profile in FIG. 7, and 12.88 μm for the surface profile in FIG. 8. With these surface profiles it has been possible to achieve a marked improvement in the surfing characteristics.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1-37. (canceled)

38. Composite body comprising:
a) a core;
b) a laminate coating at least partially surrounding the core without delamination; and
c) at least one of:
i) a positive pressure is one of present in a portion of the core partially surrounded by the laminate coating without delamination and a positive pressure is achievable in the portion of the core without delamination, the core at least partially including an open-cell foam, and
ii) a positive pressure is one of present in a portion of the laminate coating without delamination and a positive pressure is achievable in the portion of the laminate coating without delamination, the core at least partially including open-cell foam.

39. Composite body according to claim 38, wherein:
a) a device is provided for adjusting the negative or positive pressure.

40. Composite body according to claim 39, wherein:
a) the device is a valve.

41. Composite body according to claim 38, wherein:
a) the core is at least partially material-free.

42. Composite body according to claim 38, wherein:
a) the open-foam includes one of acrylic, EPS, PU, PVC, PET, and PP foams, TDI, PE, PEI, MDI, balsa wood, maize, and honeycomb.

43. Composite body according to claim 38, wherein:
a) the core includes a channel-like element which extends at least partially through the core.

44. Composite body according to claim 38, wherein:
a) the core includes at least one honeycomb-like structural element.

45. Composite body according to claim 38, wherein:
a) the core includes in part a combination of foams.

46. Composite body according to claim 38, wherein:
a) the core includes in part one of fiber mats, plates sewn through with fiberglass, and fiber-reinforced foams.

47. Composite body according to claim 38, wherein:
a) the positive pressure is achieved by at least one of air, nitrogen, noble gas, and a fluid.

48. Composite body according to claim 38, wherein:
a) the laminate coating includes an opening element.

49. Composite body according to claim 48, wherein:
a) the composite body included a pressure measuring element.

50. Composite body according to claim 39, wherein:
a) the device for adjusting the negative or positive pressure includes one of a cover element and an element embedded in the device.

51. Composite body according to claim 38, wherein:
a) the laminate coating includes one of:
i) a fabric laminate and a matrix compound, with an intermediate layer between the core and the laminate coating, and
ii) an intermediate layer between a core layer of the laminate coating and at least a portion of the laminate coating, the intermediate layer having a foam layer which is provided with indentations.

52. Composite body according to claim 51, wherein:
a) the intermediate layer includes material of one of the core layer, and the matrix compound.

53. Composite body according to claim 52, wherein:
a) the intermediate layer includes material of the fabric laminate.

54. Composite body according to claim 53, wherein:
a) the indentations are grooved.

55. Composite body according to claim 54, wherein:
a) at least sections of fabric laminate are situated in the grooves at least in places.

56. Composite body according to claim 54, wherein:
a) the grooves have a depth of up to 6 cm.

57. Composite body according to claim 54, wherein:
a) the grooves are one of parallel and intersect one another.

58. Composite body according to claim 51, wherein:
a) the indentations are countersunk.

59. Composite body according to claim 58, wherein:
a) the countersunk indentations are one of conical and cylindrical, and have a depth of up to 8 cm.

60. Composite body according to claim 53, wherein:
a) the indentations are situated uniformly.

61. Composite body according to claim 53, wherein:
a) the indentations are situated nonuniformly.

62. Composite body according to claim 51, wherein:
a) the fabric laminate is one of synthetic fibers, natural fibers, glass fibers, aramid fibers, polyethylene fibers, polypropylene fibers, mixed fibers, carbon fibers, PMI fibers, glass filament fabric, carbon fabric, fiberglass fabric, hemp fiber fabric, Dyneema fibers, bamboo fabric, texalium fibers, cotton fibers, Kevlar fibers, basalt fabric, and Parabeam.

63. Composite body according claim 51, wherein:
a) the fabric weight per unit area for glass fibers and aramid is up to 1000 g/m².

64. Composite body according to claim 51, wherein:
a) the fabric laminate includes one of a plain weave, 1/3 twill, 2/2 twill, unidirectional, glass staple fiber fabric, glass roving fabric, satin fabric, multilayer carbon fabric, and biaxial multilayer structure.

65. Composite body according to claim 38, wherein:
a) the open-cell foam includes one of polyurethane, polystyrene, SAN, SP 110 polymer foam, XPS foam, PMI foam, phenol foam, and PMA foam.

66. Composite body according to claim 38, wherein:
a) the core includes a closed cell structure.

67. Composite body according to claim 38, wherein:
a) the core includes a foam having an open cell structure.

68. Composite body according to claim 51, wherein:
a) the matrix compound includes one of a natural resin, a synthetic resin, an unsaturated polyester (UP) resin, an epoxy (EP) resin, a vinyl ester (VE) resin, and a polyurethane (PU) resin.

69. Composite body according to claim 38, wherein:
a) fillers are added to the matrix compound.

70. Composite body according to claim 69, wherein:
a) the fillers are hollow glass beads, nanoparticles, talcum, wood flour, glass fiber chips, fiberglass chips, cotton flock, microballoons, powdered aluminum, ground carbon fibers, chalk, quartz powder, ground hemp fibers, silicic acids, and dyes, or a combination thereof.

71. Composite body according to claim 38, wherein:
a) the laminate coating is gas-tight.

72. Composite body according to claim 39, wherein:
a) the respective negative and positive pressure in the core and in the laminate coating is independently adjustable.

73. Composite body according to claim 38, wherein:
a) a ratio of the laminate coating thicknesses on opposite sides is in the range of 1:1 to 1:3.

74. Use of a composite body according to claim 38, the use being as one of:
a) a water sport equipment item, sport equipment for surfing, a kiteboard, a wind surfboard, a paddleboard, a waterskate, sport equipment, a snowboard, a ski, a kayak, a component in aircraft construction, a wing element, wings for ultralight aircraft, aircraft elevators and rudders, a component in automotive construction and automotive assembly, a body part, a spoiler, a turret, a hood, a component in ship construction, a hull assembly, a hull, a component in wind turbines, a wind turbine blade, a wind turbine rotor blade, an underwater turbine blade, a component in building construction, a canopy, and a winter garden frame.
